(19) United States
(12) Patent Application Publication
(10) Pub. No.: US 2024/0375544 A1
(43) Pub. Date: Nov. 14, 2024

(54) DEVICE AND METHOD FOR CONTROLLING THE ENERGY CONSUMPTION IN AN ELECTRICALLY DRIVEN VEHICLE

(71) Applicant: Robert Bosch GmbH, Stuttgart (DE)

(72) Inventors: Gerald Heinrich Oettle, Esslingen Am Neckar (DE); Karsten Wehefritz, Schwieberdingen (DE); Marco Di Filippo, Pfullingen (DE); Nikolai Jakuba, Bruchsal (DE)

(21) Appl. No.: 18/579,608

(22) PCT Filed: Jun. 15, 2022
(86) PCT No.: PCT/EP2022/066271

§ 371 Date: Jan. 16, 2024

(30) Foreign Application Priority Data
Jul. 27, 2021 (DE) 10 2021 208 051.0

(51) Int. Cl. B60L 58/14; B60L 53/62

(52) U.S. Cl. CPC B60L 58/14; B60L 53/62; B60L 2240/549; B60L 2240/72; B60L 2260/22

(57) ABSTRACT

The present invention relates to the control of the closed-circuit current in an electrically driven vehicle, i.e., the limitation of the maximum power consumption of consumers in a parked electric vehicle. For this purpose, the energy requirement for reaching a charging station is calculated. The maximum closed-circuit current in the electric vehicle is adjusted on the basis of the calculated energy requirement for reaching the charging station and the actual charging state.

### BACKGROUND

The present invention relates to a device and method for controlling power consumption in a vehicle, in particular in an electrically driven vehicle.

Electrically driven vehicles typically comprise a so-called traction battery, which provides electrical energy for driving the vehicle. In addition to the electric drive system of the electric vehicle, numerous further electrical consumers are generally provided in the vehicle. These electrical consumers are supplied with electrical power, in part directly from the traction battery via a high-voltage network. In addition, a further, so-called low-voltage network is typically provided in an electric vehicle, via which electrical consumers can be supplied with electrical power. In this case, the low-voltage network can be supplied with electrical power from the traction battery by means of a DC-DC converter.

Some of these electrical consumers, such as an alarm system or a system for detecting radio keys, are still active even in a parked vehicle.

For example, DE 10 2009 046 305 A1 describes a device and a method for supplying electrical components of a low-voltage circuit in a battery vehicle with a traction battery.

### SUMMARY

The present invention provides an apparatus and method for controlling energy consumption in an electrically powered vehicle.

Accordingly, the following is provided:

A device for controlling power consumption in an electrically driven vehicle. The device for controlling power consumption comprises a control device. The control device is set up to determine a charging state of a traction battery of the electrically driven vehicle. Furthermore, the control device is set up to calculate an energy requirement for reaching a specified charging station. Moreover, the control device is set up to set a maximum closed-circuit current in the vehicle using the determined charging state of the traction battery and the calculated energy requirement for reaching the specified charging station.

The following is furthermore provided:

A method of controlling power consumption in an electrically driven vehicle, with the steps of determining a charging state of a traction battery of the electrically driven vehicle, calculating an energy requirement for reaching a specified charging station, and setting a maximum closed-circuit current in the vehicle. The maximum closed-circuit current in the vehicle is set using the determined charging state of the traction battery and the calculated energy requirement for reaching the specified charging station.

The present invention is based on the recognition that in modern vehicles, in particular in battery-electric vehicles, some consumers may still be active even at rest and require electrical energy in the process. The electrical energy required in this case is usually drawn directly or indirectly via a DC-DC converter from the traction battery of the electrically driven vehicle. As a result, the charging state of the traction battery may continuously decrease. If the charging state of the traction battery drops too much, there may be a risk that the traction battery may no longer be able to provide sufficient electrical energy to safely reach the next possible charging station for charging the traction battery.

It is therefore an idea of the present invention to take this realization into account and provide a control device for the consumption of electrical energy in the electric vehicle, which makes it possible to reliably reach a charging station for charging the traction battery even after the vehicle was shut off for a longer period of time.

For this purpose, it is provided that the energy requirement for reaching a charging station is determined, and this energy requirement is compared with the amount of energy available in the traction battery according to the charging state of the traction battery. Depending on the charging state of the traction battery and the energy requirement for reaching the desired charging station, the energy consumption of the secondary consumers in the vehicle can then be adjusted accordingly. Such secondary consumers can, for example, comprise any electrical consumer that can still be active in a vehicle while it is parked, for example. For example, such consumers may include an alarm system, a system for receiving signals from a radio key, communication systems for remote access for remote diagnosis, or for activating a heater or air conditioner remotely. Of course, any other electrical consumer in the vehicle may also be active during a parking operation or state of rest. Depending on the amount of energy available from the traction battery and the energy requirement for reliably reaching the desired charging station, a maximum energy requirement of one or more consumers can be adjusted and in particular restricted. A complete deactivation of one or more electrical consumers as a function of the charging state and the energy requirement for reaching the charging station is also possible.

Since the electrical consumers are generally supplied with a fixed, known voltage level, the power consumption corresponds to the electrical current that is taken up. Accordingly, the electrical current flowing from the vehicle on-board power system to the electrical consumers in a vehicle that is parked or shut down is referred to as closed-circuit current.

By adjusting the power consumption of the electrical consumers in a vehicle that is parked or shut down, that is, by adjusting the closed-circuit current as a function of the charging state of the traction battery and the energy requirement for reaching the desired charging station, it can thus be ensured that the traction battery is not discharged below a level which would no longer allow the vehicle to reliably reach the desired charging station by the operation of electrical consumers in a parked vehicle. In the event of a longer parking operation, this also ensures that it is possible to continue at least to the desired charging station in order to recharge the traction battery of the vehicle at this charging station.

For example, the charging state of the traction battery may be received from a battery management system of the traction battery. This battery management system may, for example, monitor the traction battery and evaluate operating parameters, such as cell voltages of the battery cells, to infer the current charging state of the traction battery.

The energy requirement for reaching the specified charging station may be calculated, for example, by means of a navigation system, for example a navigation system that is provided in the vehicle, and optionally permanently installed. For example, the shortest travel route may be calculated from a current location of the vehicle to the specified charging station. The topography along the travel route as well as any other parameters, for example weather conditions or the like, may also be considered. If necessary, current information, such as traffic messages and in particular route closures, can also be included in the planning. As a basis for calculating the energy requirement, for example, a fixed specified average energy consumption, a previously determined current average consumption, or optionally also a special consumption value, in particular a consumption value with a specified safety supplement for safely reaching the charging station, can be used as a basis.

According to one embodiment, the control device is set up to limit the maximum closed-circuit current in the vehicle to a specified threshold value. In particular, the maximum closed-circuit current may be limited to a specified threshold value if a difference between the determined charging state of the traction battery and the calculated energy requirement for reaching the specified charging station falls below a specified threshold value. If necessary, a multi-stage limitation of the maximum closed-circuit current is also possible. For example, multiple threshold values for the maximum difference between he charging state of the traction battery and energy requirement for reaching the charging station may also be provided. In this case, the maximum allowable closed-circuit current in the vehicle can be reduced further if one of these threshold values falls below this threshold value. A gradual degradation of energy consumption in the electric vehicle can thereby be realized.

According to one embodiment, the control device is set up to completely deactivate one or more electrical consumers in the vehicle. For example, depending on the energy requirement to reach the desired charging station and charging state of the traction battery, one or more functions may be disabled. For example, comfort functions such as communication links for remote access or activation of an air conditioner or heater may be disabled to reduce idle power and associated power consumption. Additionally or alternatively, the control device may also be designed to deactivate individual functions or at least partial functions of one or more electrical consumers, depending on the energy requirement for reaching the charging station and on the charging state of the traction battery. For example, energy-intensive sensors of an alarm system may be deactivated first. In this case, the alarm system may optionally be operated at least in part on the basis of further, less energy-intensive sensors in order to minimize the closed-circuit current in the vehicle.

According to one embodiment, the device for controlling energy consumption in the vehicle comprises a parking detector. The parking detector may be set up to detect a condition in which the vehicle is parked or shut down. For example, such a state may be detected when a parking brake of the vehicle has been engaged or the electric drive system has been disabled. Accordingly, the control device can be designed to adjust the maximum closed-circuit current in the vehicle, and in particular, to limit it only when the vehicle is parked. If the vehicle is not parked or if the drive of the vehicle is active, however, the maximum closed-circuit current in the vehicle is not restricted. Alternatively, it is also possible to limit the secondary consumers in the vehicle if it is determined during the journey that a specified charging station can otherwise no longer be reliably reached based on the current charging state of the traction battery.

According to one embodiment, the device for controlling energy consumption in the vehicle comprises a selection device. The selection device is set up to determine one or more charging stations for charging the vehicle. The selection device is further set up to select a charging station from among the determined charging stations. The selection may be performed either automatically or based on user input. In this case, the control device is set up to calculate the energy requirement for reaching the selected charging station. For example, the determination of the one or more charging stations by the selection device for charging the vehicle may comprise automatically identifying one or more charging stations in the spatial environment surrounding the vehicle. For example, all charging stations known in a specified circumference around the vehicle may be identified. Additionally, charging stations not included in the map, particularly private charging stations, may be added to the selection list of identified charging stations.

Alternatively, the spatially closest charging station can also be automatically identified and selected by the selection device.

According to one embodiment, the device for controlling energy consumption in the vehicle comprises a communication device. The communication device is set up to receive information about charging stations for charging the traction battery of the vehicle. In particular, the information about the charging stations may be received from a remote server or any other communication partner. In this case, the information can be received via any suitable communication link, in particular a wireless communication link, for example a mobile telephone link or the like. For example, the communication device may establish a radio connection for retrieving information about charging stations from the internet. The received information about the charging stations may be provided to the selection device. The selection device may thereby automatically select a charging station from the received information, or the selection may be performed by a user.

According to one embodiment, the device for controlling energy consumption in the vehicle comprises a memory. The memory is set up to save charging station information for charging the vehicle. The memory is further set up to provide the saved information about charging stations for charging the traction battery to the selection device. For example, data about a suitable charging station may be stored in the memory device in the form of a map or in any other suitable manner, for example in table form or the like. In particular, information about local saved charging stations in a specified circumference around the current position of the vehicle may be provided to the selection device.

According to one embodiment, the memory is set up to save information about charging stations that have previously been used to charge the traction battery of the vehicle. For example, during a charging operation, the relevant information about the charging station used can be automatically saved in the memory. Accordingly, the selection device may be set up to automatically select one or more charging stations using the information concerning the charging stations that have already been used to charge the traction battery of the vehicle. For example, automatic selection by the selection device may take parameters such as geographic location, in particular the distance between the charging station and the current location, the maximum charging power provided by the respective charging station, costs, user preferences, for example frequency of previous use of a charging station, time of last charging, or the like into account.

For example, information about a charging station may include data such as geographic location, maximum charging power, cost of charging, information about the charging station provider, types of plugs available at the charging station, or any other data.

According to one embodiment, the device for controlling energy consumption in the vehicle comprises a notification device. The notification device is set up to output a notification if the control device restricts the maximum closed-circuit current in the vehicle, and in particular, sets it below a specified threshold value. The notification may generally comprise any type of notification. For example, an optical or audible signal may be issued when the vehicle is stopped if the closed-circuit current is already limited or will foreseeably be limited when the vehicle is stopped. Furthermore, for example, the notification may also be made by means of a radio connection to another communication device, for example a cell phone of the user or the like. For example, a short message may be transmitted to the user's cell phone. Further, the notification is also possible by means of a special app on the cell phone of the user. In this case, for example, a measure of the restriction of closed-circuit current may also be displayed to the user. For example, the user may be shown whether the function of one or more consumers has been restricted or wholly deactivated. Furthermore, it is also possible to point a user to the specified charging station via the position or the travel route with this app. If appropriate, the user may also specify a desired charging station using the app, or select from a list of available charging stations. Moreover, any further interactions between a user and the device for controlling power consumption are also possible, in particular by means of the notification device.

The embodiments and further developments hereinabove can be combined with one another as desired, to the extent that they are advantageous. Further embodiments, developments, and implementations of the invention also include combinations of features of the invention not explicitly specified hereinabove or hereinafter with respect to the exemplary embodiments described. The skilled person will in particular also add individual aspects as improvements or additions to the respective basic forms of the invention.

### BRIEF DESCRIPTION OF THE DRAWINGS

Further features and advantages of the invention are explained hereinafter with reference to the drawings. Shown are:

FIG. 1: a schematic representation of an electrical on-board power system of an electric vehicle with a device for controlling power consumption, according to one embodiment;

FIG. 2: a schematic representation of a block diagram of an apparatus for controlling power consumption, according to one embodiment; and

FIG. 3: a flow chart as underlying a method of controlling power consumption, according to one embodiment.

### DETAILED DESCRIPTION

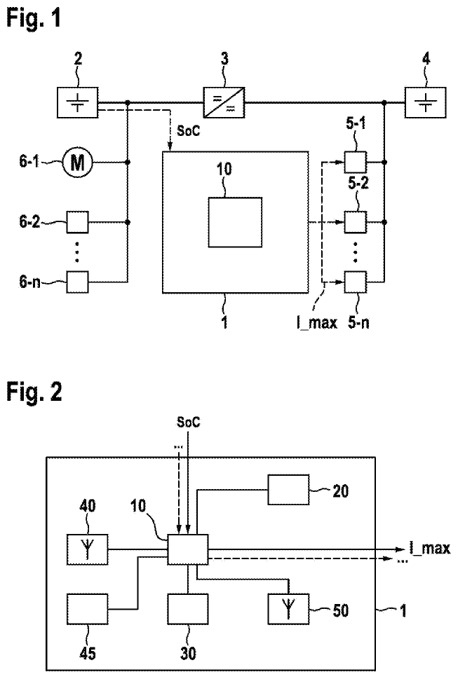

FIG. 1 shows a schematic representation of a block diagram for an electrical power system in an electrically driven vehicle. Electrically driven vehicles, in particular battery-electric vehicles, comprise a so-called traction battery that provides the electrical energy to propel the vehicle. For this purpose, the traction battery 2 generally provides an electrical voltage of several hundred volts, for example approximately 400 V. However, other output voltages of the traction battery are generally also possible. For example, the traction battery may also provide an electrical voltage in the amount of approximately 800 V. The electric voltage supplied by the traction battery 2 may be provided to an electric drive system 6-1 on the one hand. Moreover, further consumers 6-2 to 6-n can also be directly supplied with electrical energy from the traction battery 2. For example, the traction battery 2 may directly supply electrical energy to an electric heater, an air conditioner, or the like.

Moreover, an electrically driven vehicle generally comprises multiple electrical consumers 5-i, which are supplied with a lower electrical voltage, for example 12 V. These consumers 5-i are therefore connected to a so-called low-voltage network. The low-voltage network can be coupled to the traction battery 2 or the high-voltage network to which the traction battery 2 is connected by means of a DC-DC converter 3. Such a DC-DC converter 3 may convert the higher electrical voltage of the traction battery 2 to a lower electrical voltage for the low voltage network and provide it in the low voltage network.

In addition, an electrical energy store 4 can be provided in the low-voltage network, and can store electrical energy at the voltage level of the low-voltage network. In this case, for example, the DC-DC converter 3 may charge the electrical energy store 4 of the low-voltage network by means of electrical energy from the traction battery 2. The electrical consumers 5-i can then be supplied with electrical power in the low-voltage network from the electrical energy store 4. If the charging state of the electrical energy store 4 falls below a specified threshold value, the electrical energy store 4 can again be recharged with electrical energy from the traction battery 2 via the DC-DC converter 3.

The electrical consumers 5-i of the low-voltage network can be any electrical consumer of a vehicle, in particular an electric vehicle. For example, the electrical consumers 5-i of the low-voltage network may comprise an electrical control unit, components of an entertainment system, electric window controls, actuators for seat adjustment, a fan, and/or a power supply for any sensors and/or actuators. Moreover, the electrical consumers 5-i in the low-voltage network may comprise components for an alarm system, a system for detecting radio keys, communication components for remote access to the vehicle, or remote control of vehicle components. Of course, any other electrical consumers 5-i are also possible in the low-voltage network of the vehicle.

As can be seen from the above description, electrical energy is required to supply power to the components in the low-voltage network, but also for the high-voltage consumers 6-2 to 6-n. Since this electrical energy is also directly or indirectly withdrawn from the traction battery 2, this proportion of the electrical energy is not available to drive the electric vehicle. By drawing electrical energy from the traction battery 2 to supply the consumers 5-i and 6-2 to 6-n, the range of the electric vehicle, i.e., the maximum distance that the electric vehicle can travel with the electrical energy stored in the traction battery 2, thus decreases.

Some of the electrical consumers 5-i described above in the low-voltage network may also be active in a vehicle that is parked or shut down. For example, an alarm system may monitor the vehicle interior and/or vehicle status by means of sensors, and output an optical and/or audible alarm signal when the alarm system is triggered. Further, for example, a system for detecting radio keys may also be continuously active in order to detect a radio signal of such a radio key and subsequently drive corresponding actuators for unlocking or locking the vehicle. In addition, a communication link can also be established for a parked vehicle, for example. By means of such a communication link, for example, diagnostic data may be read, the software in the vehicle may be updated, or components of the vehicle such as an air conditioning system or heater may be controlled remotely. If one or more electrical consumers 5-i are active in the low-voltage network in a parked vehicle, electrical energy is therefore also drawn from the traction battery 2 in a parked vehicle. Accordingly, even for a parked vehicle, the maximum travel distance that can be traveled with the remaining electrical energy stored in the traction battery 2 also decreases.

If no charging option is available at the current parking position of a vehicle, the vehicle must first be driven to a suitable charging station to further charge the traction battery 2. For this purpose, in a battery-electric vehicle, electrical energy is required from the traction battery 2. However, if electrical energy is withdrawn from a parked vehicle as described above by operation of electrical consumers in the parked state of the traction battery 2, it may not be ensured that the remaining electrical energy stored in the traction battery 2 is still safely sufficient to reach a suitable charging station. In such a case, there is a risk that the electric vehicle may run out of power on its way to a charging station, even if sufficient electrical energy was still stored in the traction battery 2 at the start of the parking process.

In order to prevent such undesirable power loss, the closed-circuit current in a vehicle, that is, the electrical power consumption in the parked state of the vehicle, may be controlled by means of a device 1 for controlling power consumption. For this purpose, the device 1 for controlling power consumption can adjust the closed-circuit current, i.e., the energy requirement of the electrical consumers 5-i in the low-voltage network, but also optionally the electrical consumers 6-2 to 6-n in the high-voltage network, such that the traction battery 2 is only discharged to the extent that it can still safely reach a suitable charging station for charging the traction battery 2.

The device 1 for controlling power consumption comprises a control device 10. This control device 10 determines the current charging state SoC of the traction battery 2. For example, a value of the current charging state SoC may be provided by a battery management system of the traction battery 2 at the control device 10 of the device 1 for controlling power consumption. Further, the control device 10 calculates an energy requirement that is needed to reach a specified charging station for charging the traction battery. Determining the specified charging station as well as accurately calculating the energy requirement for reaching this charging station will be explained in more detail below. The control device 10 can then set the maximum closed-circuit current I_max, i.e., the maximum energy requirement by the consumers 5-i, taking the current charging state SoC and the energy requirement to reach the specified charging station into account. In particular, the control device can limit the maximum closed-circuit current I_max, such that the charging state of the traction battery 2 does not decrease below a value required to reach the specified charging station due to the energy consumption of the consumers 5-i.

For example, in a simple embodiment, the charging state SoC of the traction battery 2 may be compared to the energy requirement to reach the specified charging station. If the difference between the charging state SoC of the traction battery 2 and the energy requirement for reaching the charging station exceeds a specified threshold value, then the consumers 5-i can continue to operate without restrictions in the simplest configuration. If the difference between the charging state SoC and the energy requirement for reaching the charging station is below the specified threshold value, then the consumers 5-i can be deactivated in this simple configuration. Where appropriate, some selected consumers may also continue to operate 5-i to provide minimal emergency functionality.

Moreover, however, more complex and in particular multi-stage approaches to degradation of the power consumption of the consumers 5-i are also possible, depending on the ratio between the charging state SoC of the traction battery 2 and the amount of energy required to reach a charging station. For example, all consumers 5-i can initially continue to operate without restriction above a specified first threshold value. If the first threshold value is not met, some consumers 5-i, for example a first group of consumers 5-i, may subsequently be deactivated and/or restricted in function. If a further threshold value is exceeded, additional consumers 5-i, for example, can then be deactivated or limited in their function. Furthermore, it is also possible to further restrict the function of consumers 5-i that have already been previously restricted in their function. Finally, if the energy supply drops below a further threshold value, all or nearly all consumers 5-i can be deactivated. As already mentioned above, only an emergency functionality can optionally be provided by one or more consumers that have the lowest possible power consumption.

Any suitable approaches are possible for restricting the functionality of a consumer 5-i listed above. If a consumer 5-i, for example, uses sensor data from multiple sensors, these sensors, for example sensors with a high energy requirement, can first be deactivated. In that case, the respective consumer may provide 5-i with limited functionality, if appropriate, based on the remaining sensors that are still active. For example, in an alarm system, monitoring of the vehicle interior and vehicle status may initially be performed by means of a plurality of sensors. If the threshold value for the ratio between the charging state SoC and the energy requirement for reaching the charging station is exceeded, some of these sensors may be deactivated. Moreover, for example, the querying intervals for sensors by a consumer 5-i can also be reduced so as to lower the energy requirement. Of course, any other concepts for reducing the energy requirement are also possible, in particular by restricting functionality or the like.

Restricting the functionality or disabling consumers 5-i, as already described, can take place as a function of a specified limit or threshold values. For example, a ratio, i.e., a quotient between energy requirement for reaching the specified charging station and the charging state SoC of the traction battery, can be calculated. Moreover, the threshold values may also be calculated as a function of a difference between the energy requirement for reaching the specified charging station and the charging state SoC of the traction battery 2. Of course, any other mathematical approaches to assess the charging state SoC of the traction battery 2 as a function of the energy required to reach the specified charging station are also possible.

FIG. 2 shows a schematic representation of a block diagram of a device 1 for controlling energy consumption in an electrically driven vehicle, in particular in a battery-electric vehicle. The device 1 for controlling power consumption shown herein may be, for example, the device 1 for controlling power consumption as previously described in connection with the electrical on-board power system. Accordingly, all of the statements already made above also apply to the device 1 for controlling energy consumption as described below. Analogously, the properties of the device 1 as described below for controlling power consumption may also be applied to the device 1 for controlling power consumption as described above in connection with FIG. 1.

In addition to the control device 10 already described above, the device 1 for controlling power consumption may comprise, for example, a parking detector 20. This parking detector 20 may monitor the vehicle and detect whether the vehicle is shut down; for example, parked. For example, it may herein be detected whether a parking brake has been activated in the vehicle. Additionally or alternatively, the parking detector 20 may also monitor whether or not the components of the electric drive system of a vehicle are active. For example, if the components of the electric drive system, in particular the components of an electric power converter, are found to be inactive in the electric drive system, or a circuit breaker is opened between the traction battery and the components of the electric drive system, the vehicle may also be assumed to be shut down or parked. Of course, the parking detector 20 may also monitor any further or other components to determine the current operating status of the vehicle. For example, the parking detector 20 may also monitor whether the vehicle is locked or whether a person is currently in the interior of the vehicle.

If, for example, it is detected by means of the aforementioned parking detector 20 that the vehicle has currently been parked and is thus in a parking state, control of the closed-circuit current can be activated as previously described. In this way, it can be ensured that even after a vehicle has been parked, in particular even after a longer rest period, sufficient electrical energy is still stored in the traction battery 2 of the vehicle to reach a charging station for charging the traction battery.

The charging station which is to be reached with the electrical energy stored in the traction battery 2 can be defined in any suitable way. For example, a user may manually specify the charging station to be reached. For this purpose, the user can specify a desired charging station to be reached, for example via a suitable input device in the vehicle or via an application (app) on a cell phone or the like via a radio connection.

Alternatively, it is also possible for a charging station suitable for charging the electric vehicle to be automatically determined.

The selection of a charging station for charging the traction battery 2 can be carried out, for example, by means of a selection device 30. The selection device 30 can be integrated in the device 1 for controlling the energy consumption, for example. For example, information about suitable charging stations for charging the vehicle may be saved locally in a memory 45 in the vehicle, in particular in the device 1 for controlling power consumption. This information may be transmitted, for example, via a wired or radio interface from a remote database to the local memory 45. Additionally or alternatively, it is also possible to determine the respective information about this charging operation and the charging station used during a charging operation of the traction battery 2 at a charging station, and to save it in the local memory 45. In this way, a database of information about available charging stations may be automatically built or supplemented. In this way, in particular, current user preferences for using particular charging stations can also be automatically determined and saved in the memory 45.

The information stored in the local memory 45 or retrieved from a remote database as further discussed below may include any suitable information. For example, the information may include the geographic location of the charging station, a maximum retrievable charging power, a connection type (plug type) of the charging station, cost of a charging operation, information about the charging station provider, availability time constraints, or any other information.

In addition to locally saving the information about available charging stations as detailed above, it is additionally or alternatively also possible to

retrieve information about available charging stations from a remote database by means of a communication device 40. For this purpose, the communication device 40 may comprise a radio interface, for example, via which a data connection to an external communication partner can be established. For example, a mobile connection, a WLAN connection, or any other radio connection may be established for this purpose. For example, a communications link can be established on the internet to retrieve information about available charging stations from the internet. However, it is also possible to establish a communication connection to a specific database server, for example a service provider, in particular in the cloud. In this case, for example, real-time information about the availability and expected costs can also be retrieved.

Further, it is also possible to retrieve navigational data via the communication device 40. For example, the device 1 may transmit the current position of the vehicle to a remote server via the communication device 40 to control power consumption. As a return response, the communication device 40 can also receive navigation data, for example a route guide to one or more proposed charging stations, in addition to information about one or more available charging stations. Where appropriate, the amount of energy required to reach the proposed charging station may already be calculated by the external server and transmitted to the communication device 40.

Alternatively, it is also possible for route planning to a charging station to be determined by means of a navigation device that is locally installed in the vehicle. The energy requirement for reaching the charging station may also be determined locally in the vehicle. For example, a specified consumption value may be used as the basis for calculating the necessary energy requirement. This consumption value may also include a safety supplement, where appropriate, to ensure that the planned charging station can also be reliably reached without running out of power on the way. Alternatively, it is possible for previously determined consumption values for the vehicle, for example, consumption values of the past within a specified period of time or the last travel path, for example the last 50 or 100 km, to be used to calculate the power consumption to the charging station. In this case as well, an additional safety supplement can be added to ensure that the charging station is safely reached. Furthermore, it is also possible to consider topographical conditions in the route planning and include them in the calculation of the expected energy consumption to reach the charging station. For example, a higher power consumption may be expected to reach a charging station at a geographically higher point. Correspondingly, for a charging station which is geographically lower than the current position of the vehicle, a lower consumption for reaching the charging station can be used as a basis. In addition, for example, weather conditions or further general conditions which have an impact on the expected energy consumption may also be considered.

The charging station which is to be used for charging the traction battery can be manually specified by a user, as previously stated. For example, a user may directly input a desired charging station via a user interface, for example into the selection device 30. Alternatively, it is also possible for the selection device 30 to initially automatically determine one or more charging stations in a circumference, for example, in a specified radius around the current position of the vehicle, and display the determined charging stations to a user. Accordingly, the user may select a desired charging station at which the next charging operation is to occur from among the charging stations indicated in the vicinity of the vehicle. The determination of the charging stations in the environment may be made either, as previously described, based on the information locally saved in the memory 45 concerning charging stations. Additionally or alternatively, information about charging stations in the vicinity of the vehicle may also be retrieved from a remote database via a communication link, for example via the communication device 40.

Alternatively, it is also possible for the selection device 30 to automatically select a suitable charging station. For example, the selection device 30 may automatically select the charging station that is closest to the current location of the vehicle. For this purpose, either the shortest travel distance to a charging station or the shortest route by air to a charging station can be used as the basis. Further preferences of a user for automatically selecting a charging station may also be considered. For example, the charging station may also be selected in consideration of costs for a charging operation, the desired charging power for a charging operation, a particular provider of charging stations, or any other parameters. Also, for example, user preferences that were previously automatically determined may be considered. For example, if there is a charging station in a specified circumference around the vehicle at which the user has previously charged one or more times, such a charging station may be preferentially selected.

If, in the case of a vehicle that is parked or shut down, the closed-circuit current I_max is limited by the device 1 for controlling power consumption, in particular by the control device 10, and thus one or more components 5-i of the vehicle are deactivated or at least functions of these components 5-i are restricted, a user may also be informed of such a restriction. For example, a notification device 50 may be provided in the device 1 for controlling power consumption. If, for example, it is determined immediately after shutting down or parking the vehicle that a restriction of the maximum closed-circuit current I_max is required, the user may be informed thereof visually and/or acoustically by a corresponding output within the vehicle.

For example, the user may be shown that the functions of an alarm system are limited or the alarm system has been completely deactivated to reduce the closed-circuit current. If necessary, a user may also be informed that later unlocking of the vehicle by means of a radio key is not possible, or at least might not be possible, if the corresponding system for monitoring an external radio key has been deactivated or restricted.

In addition to the immediate display in the vehicle, it is also possible for the notification device 50 to establish a communication connection to another device of the user. In this case, the notification device 50 may also inform the user about a later restriction on the closed-circuit current and when there is a related deactivation or restriction of components 5-i. For example, the notification device 50 may send a short message (SMS) to a cell phone of the user. Additionally or alternatively, a notification may also be sent to an application on a cell phone (app). In this case, the user may also be informed of the expected limitations due to the restriction of the closed-circuit current I_max. Further, upon automatically selecting the charging station, the user may also be informed of the selected charging station and, optionally, the travel route to that charging station via the notification device 50. Furthermore, any further functions for exchanging data between the notification device 50 and a remote device, for example a user's cell phone, are also possible. In particular, the cell phone and an application installed thereon may also be used to make corresponding settings for configuring the device 1 to control power consumption. For example, the user may also select, via the application on the cell phone or other device, a desired charging station to be utilized to recharge the traction battery 2 at a later date. Furthermore, for example, specifications for automatically selecting a charging station via the application on the remote device are also possible.

In addition to the information about the charging state SoC of the traction battery, any other relevant data can, in principle, be provided to the device 1 for controlling energy consumption, in particular the control device 10. For example, information about the vehicle status, current demand of individual consumers, or map data may be provided as additional data. This is shown in FIG. 2 by a dashed arrow pointing to the control device 10.

Further, the device 1 for controlling power consumption, in particular the control device 10, can also output further data, such as a degradation level, in addition to the maximum closed-circuit current I_max. For example, such a degradation level may specify which consumers, in whole or at least in part, should be disabled. This is shown in FIG. 2 by a dashed arrow from the control device 10.

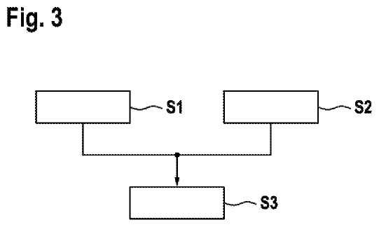

FIG. 3 shows a flow chart as it underlies a method for controlling power consumption in an electrically driven vehicle, in particular a battery electric vehicle. In step S1, the charging state of a traction battery 2 of the electrically driven vehicle is determined.

In step S2, an energy requirement to reach a specified charging station is calculated. Herein the charging station can be specified automatically or input manually by a user, as already stated above.

In step S3, a maximum closed-circuit current is set, i.e., a restriction of a maximum energy requirement of the consumers in the electrically driven vehicle. The maximum closed-circuit current is set in particular using the determined charging state of the traction battery 2 and the calculated energy requirement for reaching the specified charging station.

Moreover, the method of controlling power consumption may, of course, also comprise any further steps as previously described in connection with the device 1 for controlling power consumption.

In summary, the present invention relates to controlling the closed-circuit current in an electrically driven vehicle, i.e., limiting the maximum power consumption of consumers in an electric vehicle that is shut down. For this purpose, the energy requirement for reaching a charging station is calculated. The maximum closed-circuit current in the electric vehicle is adjusted on the basis of the calculated energy requirement for reaching the charging station and the actual charging state.

1. A device (1) for controlling power consumption in an electrically driven vehicle, the device (1) comprising:
a control device (10) configured to determine a charging state of a traction battery (2) of the electrically driven vehicle, calculate an energy requirement for reaching a specified charging station, and set a maximum closed-circuit current (I_max) in the electrically driven vehicle using the determined charging state of the traction battery (2) and the calculated energy requirement for reaching the specified charging station.

2. The device (1) according to claim 1, wherein the control device (10) is configured to limit the maximum closed-circuit current (I_max) in the vehicle to a specified threshold value when a difference between the determined charging state of the traction battery (2) and the calculated energy requirement for reaching the specified charging station falls below a specified threshold value.

3. The device (1) according to claim 1, wherein the control device (10) is configured to completely deactivate one or more electrical consumers (5-i) of the vehicle and/or deactivate functions of one or more electrical consumers (5-i) of the vehicle.

4. The device (1) according to claim 1, further comprising a parking detector (20) configured to detect a condition in which the vehicle is parked,
wherein the control device (10) is configured to set the maximum closed-circuit current (I_max) in the vehicle when the vehicle is parked.

5. The device (1) according to claim 1, further comprising a selection device (30) configured to determine one or more charging stations for charging the vehicle, and selecting a charging station from the determined one or more charging station vehicles;
wherein the control device (10) is configured to calculate the energy requirement for reaching the selected charging station.

6. The device (1) according to claim 5, further comprising a communication device (40) configured to receive information about charging stations for charging the traction battery (20) of the vehicle from a remote server and provide the received information to the selection device (30).

7. The device (1) according to claim 5, further comprising a memory (45) configured to store information about charging stations for charging the vehicle and provide the information about charging stations stored in the memory (45) for charging the traction battery (2) of the vehicle at the selection device (30).

8. The device (1) according to claim 7, wherein the memory (45) stores information about charging stations previously used to charge the traction battery (2) of the vehicle, and
wherein the selection device (30) is configured to automatically select one or more charging stations using the information concerning charging stations used to charge the traction battery (2) of the vehicle.

9. The device (1) according to claim 1, further comprising a notification device (50) set up to output a notification if the control device (10) sets the maximum closed-circuit current (I_max) in the vehicle below a specified threshold value.

10. The device and method for controlling the energy consumption in an electrically driven vehicle, the method comprising:
determining (S1) a charging state of a traction battery (2) of the electrically driven vehicle;
calculating (S2) an energy requirement to reach a specified charging station; and
setting (S3) a maximum closed-circuit current (I_max) in the electrically driven vehicle using the determined charging state of the traction battery (2) and the calculated energy requirement to reach the specified charging station.
